(19) United States
(12) Patent Application Publication
(10) Pub. No.: US 2009/0039675 A1
(43) Pub. Date: Feb. 12, 2009

(54) VEHICLE BODY WITH PASSENGER COMPARTMENT OVER CARGO BED

(76) Inventors: E. Mackey King, Howell, MI (US); Paul Lester, Commerce Twp, MI (US); Gerard R. Olszewski, Temperance, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/836,398

(22) Filed: Aug. 9, 2007

(51) Int. Cl. B62D 33/00

(52) U.S. Cl. 296/182.1

(57) ABSTRACT

A vehicle having a passenger compartment with front and rear seats and a cargo compartment behind the passenger compartment. The passenger compartment includes a floor that is stepped upwardly under the rear seat to form an open space thereunder. The cargo bed extends into the open space under the rear seat to provide a long bed feature that is permanently available without requiring physical manipulation of the cargo compartment. A rear wall of the passenger compartment includes a downwardly openable midgate that cooperates with folding/tumbling sections of the rear seat to provide a second tier load floor. An optional liftgate in the passenger compartment rear wall provides an enhanced height second tier load compartment.

### FIELD OF THE INVENTION

This invention pertains to the field of pick up truck vehicles of the type having a crew cab passenger compartment and a short bed cargo compartment extending rearwardly of the passenger compartment that offers the functional convenience of long bed cargo capability.

### BACKGROUND OF THE INVENTION

Generally, pick-up truck vehicles today are available in a variety of cabin and cargo box arrangements to offer a variety of options for potential customers' needs. Common cabin configurations include, among others, crew and quad cab configurations. These configurations generally result in lengthening the cabin so as to accommodate a rear seat assembly. Often, when one of these configurations is selected, a smaller cargo box, such as a short bed, is selected in an attempt to offset the increased cabin length so as to not increase an overall length of the vehicle. This overall configuration of a crew cab or quad cab accompanied by a shorter box has certain benefits such as not increasing the overall length of the vehicle, but it also has certain drawbacks, such as less cargo storage space.

U.S. Pat. No. 7,093,871 B2 discloses a convertible arrangement which combines the benefits of a short bed truck design with the functional convenience of a long bed feature. The arrangement utilizes a downwardly mobile lever-mounted rear seat bottom and a forwardly translatable rear cabin wall that enables the cargo bed to be extended to a long bed length. While effective for its purpose, it has the disadvantages of requiring costly mechanical devices to enable extension of the cargo bed inconvenience to the truck owner of needing to make the physical conversion when even a small amount of long cargo items are loaded. It further exposes the interior of the cabin to the elements when the rear wall is translated forward.

U.S. Pat. No. 6,837,531 B2 discloses another convertible arrangement in which the rear seat bottom is pivoted forward and the rear seat back is pivoted upwards to provide a space that allows the forward wall of the cargo compartment to the translated forward into the cabin to extend the cargo bed. This again is an effective technique but also suffers from mechanical complexity and the inconvenience of having to physically perform the conversion any time long items are to be loaded.

Thus there is a need for a vehicle cabin and cargo bed arrangement that overcomes the aforementioned and other disadvantages.

### SUMMARY OF THE INVENTION

Thus, with the foregoing in mind, there is provided a simple and convenient vehicle body arrangement having a passenger compartment with front and rear seats and a cargo compartment projecting rearwardly from the passenger compartment that combines the benefit of short bed cargo compartment with the convenience of a long bed capability. In accordance with the invention, therefore, the passenger compartment includes a rear wall and a floor, wherein the floor is provided with an upwardly stepped segment integrally formed with the rear wall under at least a portion of the rear passenger seat to create an open space thereunder external to the passenger compartment. Further, in accordance with the invention, the cargo compartment is provided with a fixed cargo bed having a first portion that extends rearwardly of the passenger compartment rear wall to provide a short cargo bed and with a second portion that extends forwardly of the same rear wall into the open space under the rear seat to provide an extended cargo bed.

In another feature of the invention, the rear seat components are pivotable forward and a midgate installed in the passenger compartment rear wall is pivoted downward to form a second tier load floor bed for loads that exceed the space capacity provided by the built-in extended cargo space in the stepped portion of the passenger compartment. A liftgate is provided in the compartment rear wall to further increase the load capacity of the second tier cargo bed.

Since the space under the rear passenger seat is built into the structure of passenger compartment and since the cargo bed is fixed in place in this space, certain advantages are obtained in that there are no complex mechanisms required and no physical manipulations of the cargo compartment needed to achieve the benefits of a long bed design for many if not most of the long item loads that the truck will be used to haul. Larger loads can be easily accommodated by simply pivoting the rear seat components and opening the midgate and, optionally, the liftgate without the mechanical complexity and inconvenience of having to translate a portion of the cargo compartment to achieve an extended bed. Thus, the advantage of garaging a short bed vehicle while retaining the convenience of a fixed long bed structure is achieved

### BRIEF DESCRIPTION OF THE DRAWINGS

FIG. 1 is a diagrammatic side view of the vehicle body of the present invention;

FIG. 2 is a perspective view of the vehicle body of FIG. 1;

FIG. 3 is a diagrammatic side view of the vehicle body the invention illustrating alternative configurations available; and

FIG. 4 is a perspective view of the vehicle body of FIG. 1 further illustrating the alternative configurations shown in FIG. 3.

### DETAILED DESCRIPTION OF THE INVENTION

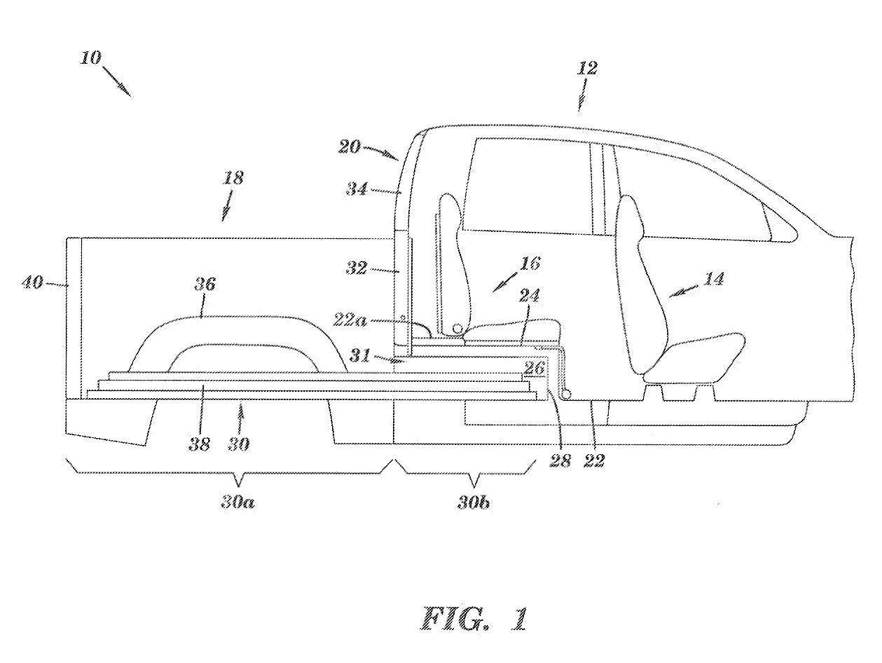

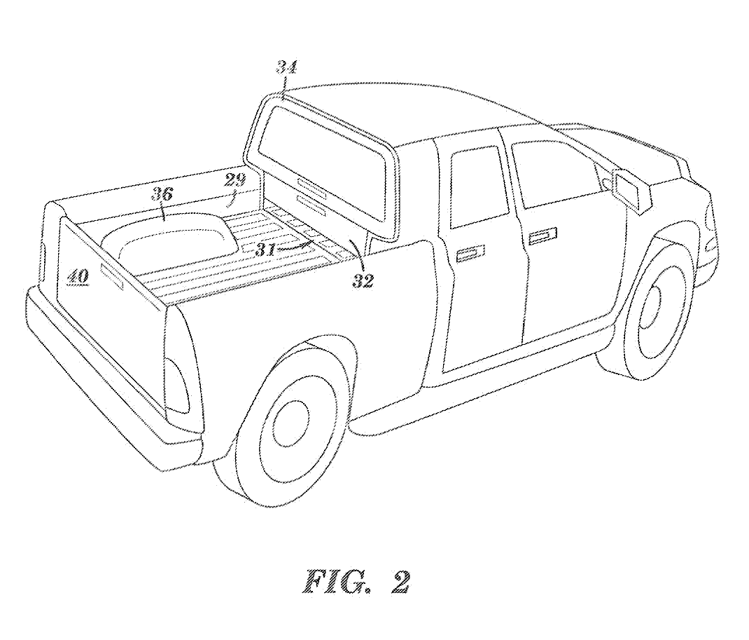

Referring to jointly to FIGS. 1 and 2 a diagrammatic illustration of a vehicle body 10 is shown which as having a passenger compartment 12, with front and rear seats 14 and 16, and a cargo compartment 18 which projects rearwardly from the passenger compartment to the left as seen in FIG. 1. The passenger compartment 12 has a rear wall 20 and a floor 22 with an upwardly stepped segment 24 integrally formed with the rear wall 20 under at least a portion of the rear passenger seat 16 to create an open space 26 thereunder external to the passenger compartment 12. Rear wall 20 optionally includes a midgate 32 and a liftgate 34. A raised portion 22a of floor 20 forms a floor for an interior storage compartment behind rear seat 16

The cargo compartment 18 is provided with a fixed cargo bed 30 having a first portion extending rearwardly of the rear wall 20 to provide a short cargo bed section 30a and a second portion extending forwardly of said wall into the open space 26 under the rear seat 16 to provide an extended cargo bed section 30b which, combined with the first short bed section 30a, creates what is commonly referred to as a long bed. To this end, the cargo compartment has a cargo front wall 28 formed with parallel forwardly extending cargo side walls 29 (only one shown) that mate into the open space 26 under the rear passenger seat. The front wall 28 and forwardly extending side walls 29 combine with the forwardly extending cargo bed portion 30b to form a compartment under the rear passenger seat with an opening 31, preferably 8 inches high, facing to the rear which provides ready access to the extended cargo bed section 30b.

This arrangement allows for easy insertion of a payload 38, such as a stack 8 inches tall of two by fours lying flat on the cargo bed, without requiring any manipulation of the physical features of the cargo compartment 18 or of the internal configuration of the passenger compartment 12. With such flat loading, other items, such as paint cans, can be carried loosely on top of the load, a safety convenience that is difficult to achieve when long items are loaded at an angle extending out over a closed tailgate 40 or when the tailgate is lowered to accommodate the longer items. The open space 26 beneath the rear seat bottom created by the stepped segment 24 is such that a useful vertical height, such as eight inches, can be provided for the extended cargo bed section 30b which is sufficient for many if not most typical do-it-yourself projects.

Preferably, the width of the opening 31 of the open space 26 is at least as wide as the width of the short bed section between opposing wheel wells 36 in the cargo compartment, of which only the leftmost wheel well is shown in FIGS. 1 and 2. In common practice, the space between the wheel wells is set at four feet which allows conventional 4×8 sheets of plywood and sheet rock panels to be loaded into the cargo compartment so as to lie flat on the cargo bed. By making the open space 26 at least the same width as between opposing the opposing wheel wells, such standard 4×8 stock can be easily accommodated.

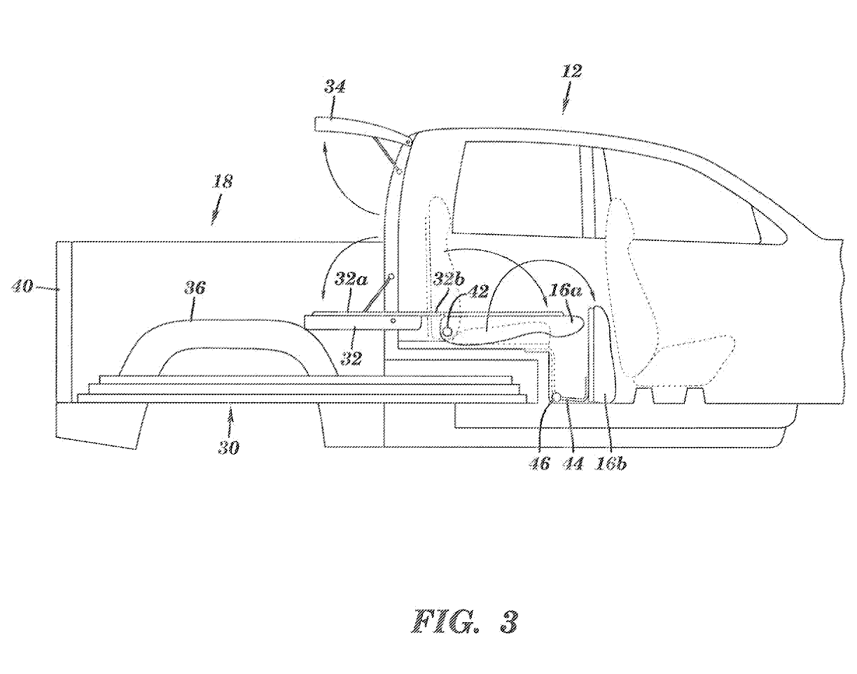

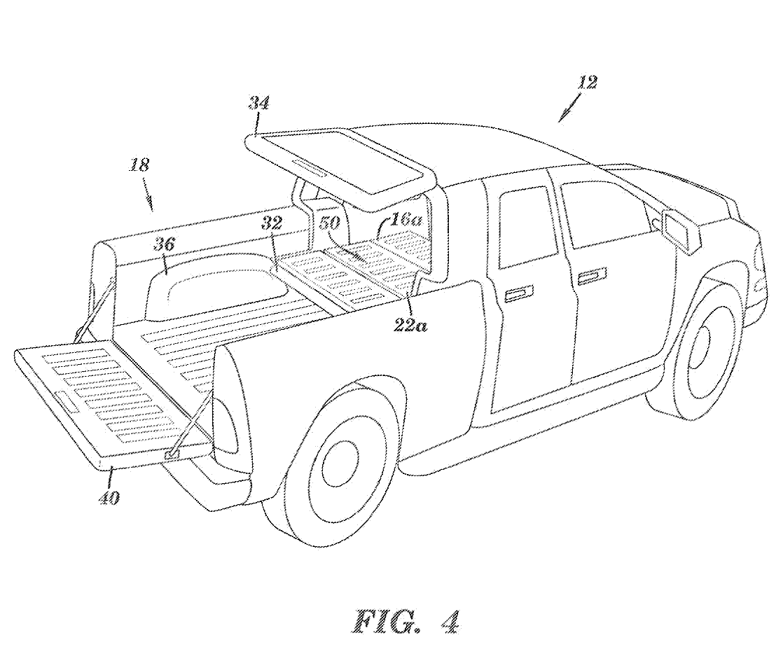

Turning now to FIGS. 3 and 4, a further feature of the invention is shown in which rear wall 20 is provided with a downwardly opening midgate 32 and an optional liftgate 34. Further, the rear seat 16 includes a back section 16a and a bottom section 16b. The back section 16a is mounted in known manner at hinge mounts 42 to allow the seat to be folded flat as shown in FIG. 3. The bottom section 16b is mounted to a lever arm 44 which is mounted on pivot mounts 46 to allow the bottom section to be tumbled forward as shown in FIG. 3. Opening the midgate downward and folding/tumbling the rear seat 16, as shown, provides a second tier load floor 50 that markedly increases to load capacity of the truck. Additionally, this is accomplished without requiring extensive manipulation of the cargo compartment.

As illustrated in FIG. 4, the raised floor section 22a forms a bridge between the back side of seat back section 16a and the load floor surface 32b of midgate 32. Alternatively, as best seen in FIG. 3, the floor section 22a may be omitted and the load floor surface 32a of midgate 32 may include an extension 32b that bridges to the back section 16a. Provision of optional liftgate 34 of known construction conveniently further expands and complements the load capacity of the vehicle cargo compartment 18 by providing an enhanced height second tier cargo floor section.

The invention has been described in detail with particular reference to certain preferred embodiments thereof, but it will be understood that variations and modifications can be effected within the spirit and scope of the invention.

### PARTS LIST

10. vehicle-body.
12. passenger compartment.
14. front seat.
16. rearseat
16a. back section
16b. bottom section
18. cargo compartment.
20. rear wall
22. floor
22a. storage compartment floor
24. stepped segment
26. open space
28. cargo front wall
29. cargo side walls
30. cargo bed
30a. short cargo bed section
30b. extended cargo bed section
31. opening
32. midgate
32a. load floor surface
32b. load floor surface extension
34. liftgate
36. wheel wells
38. payload
40. tailgate
42. hinge mount
44. lever arm
46. pivot mount
50. second tier load floor

1. A vehicle body having a passenger compartment with front and rear seats and a cargo compartment projecting rearwardly from the passenger compartment, the body comprising:
the passenger compartment having a rear wall and a floor, the floor having an upwardly stepped segment integrally formed with the rear wall under at least a portion of the rear passenger seat to form an open space under the rear seat external to the passenger compartment, the rear wall including a downwardly pivotable midgate assembly that, when pivoted into the cargo compartment to an open position, forms a second tier cargo floor section over the open space; and
the cargo compartment provided with a fixed cargo bed having a first portion extending rearwardly of said rear wall to provide a short cargo bed section and a second portion extending forwardly of said rear wall into said open space under the rear seat to provide an extended cargo bed section.

2. (canceled)

3. The vehicle body of claim 1 wherein said cargo compartment includes spaced-apart, opposing wheel wells and said open space has a width dimension that is at least the same as the space between said opposing wheel wells in the cargo compartment.

4. The vehicle body of claim 1 wherein the cargo compartment comprises a front wall and forwardly extending side walls that mate into the open space under the rear passenger seat, the forwardly extending walls combining with the forwardly extending cargo bed portion to form a compartment under the rear passenger seat with an opening to the rear to provide access to said extended cargo bed.

5. The vehicle body of claim 1 wherein the passenger seat includes a bottom section and a back section, both being pivotable forward to form a cargo portion within the passenger compartment.

6. (canceled)

7. The vehicle body of claim 1 wherein the passenger compartment rear wall further includes a pivotable lift gate assembly that, when pivoted to an open position, provides an enhanced height second tier cargo floor section.

8. The vehicle body of claim 5 further comprising a bridging device providing a substantially horizontal support surface between a bottom edge of the midgate assembly and a bottom edge of the passenger seat back section whenever the midgate assembly and the passenger seat back are deployed to horizontal positions.

9. The vehicle body of claim 8 wherein the bridging device comprises a substantially horizontal second tier floor element positioned in the passenger compartment between the passenger seat and the rear wall.

10. The vehicle body of claim 8 wherein the bridging device comprises an extension of the midgate assembly.
